(19) United States
(12) Patent Application Publication
(10) Pub. No.: US 2005/0188625 A1
(43) Pub. Date: Sep. 1, 2005

(54) Archway and archway construction

(76) Inventor: Philip M. Cantrell, Morven, GA (US)

Correspondence Address: John P. Sinnott, 1007 North Patterson Street, Valdosta, GA, 31601, US

(21) Appl. No.: 10/787,776

(22) Filed: Feb. 26, 2004

(51) Int. Cl. E04B 1/32; E06B 1/04

(52) U.S. Cl. 52/86

(57) ABSTRACT

A method and structure for building archways and doors that have irregular upper edges is described. A curved lintel with a generally matching fascia that enclose a curved upper edge door are joined to door casings. A molding strip is attached to each of the casings on one side of the door. The door, casings and lintel are inserted in an opening in the building wall, the molding strips and the curved fascia being flush with the wall. Another curved lintel and set of molding strips are attached to the other side of the door to complete door installation.

### BACKGROUND OF THE INVENTION

This invention relates to archways and archway construction and, more particularly, to structure for accommodating doors that have arcuate upper ends and the like.

Passageways between rooms and entryways for doors frequently are provided with curved or arcuate entablatures. There are a number of techniques for producing these curved entablatures. All of these techniques, however, require a great deal of time, cost and labor.

Illustratively, in one of these techniques, as applied to a doorway in which the top edge of the door is curved, the builder must provide a horizontally disposed lintel or header. Each of the two header ends then are nailed to the ends of supporting studs that form the door posts or door jambs. Several wooden blocks of preselected sizes are nailed to the underside of the header in order to protrude downwardly into the space between the supporting door jambs. The lengths of these blocks moreover, are chosen to establish the desired curvature of the archway.

A piece of plasterboard is prepared by cutting it to a width that is equal to the width of the archway under construction. The length of the piece of plasterboard, moreover, is equal to the length of the curve that will form the archway. Transverse slices are made on the plasterboard piece of sufficient number, width and depth to enable the piece to be bent generally into the desired shape of the archway. The piece is then nailed to the blocks that protrude into the space between the studs.

After being nailed in place, the treated plasterboard is then coated with joint compound and covered with tape. The compound and tape are worked into the desired final shape and left to dry or to “set” for up to twenty-four hours.

Upon “setting,” or hardening, a workman returns to the archway and sands or otherwise works the structure into a shape that will provide a suitably snug fit with the curved top edge of the door that subsequently is mounted between the door jambs.

The relative ease with which a generally rectangular door is installed provides a sharp contrast to the very laborious method for building a curved entablature, described above.

In this circumstance, a hole is cut in a wall to accommodate the door and its associated molding and casing. The door is supplied to the builder with a casing attached to the door and a molding attached only to the casing on one side of the door. The door casing is inserted between and attached to the jambs to enable the molding to lay flush with the adjoining wall. The molding for the other side of the door is then also secured in place, thus completing the door installation.

Consequently, the builder, architect or the like is confronted with choosing only doors that have flat lintels or undertaking the tedious job of building an arch that will properly accommodate a door having a curved or otherwise irregular top edge. Clearly, there is a need for improved method and apparatus for providing curved archways.

### BRIEF SUMMARY OF THE INVENTION

These and other difficulties in the prior art are overcome, to a large extent, through the practice: of the invention. A door having an irregular or curved top, for example, is supplied at the building site not only with a casing for the door, but also with an arcuate lintel that forms the archway between the casings and matches the curvature of the upper edge of the door. This door with a molding attached to one side of the casing is inserted and secured between two upright door jambs to enable the molding to lay flat against the adjoining wall. The molding for the other side of the door is then secured to the exposed side of the casing to complete the door installation.

In a similar manner an arcuate passageway with a curved or irregular entablature also can be provided.

Thus, the practice of the invention overcomes many of the difficulties that have characterized the prior art. These and other features of the invention are developed in the following detailed description of a preferred embodiment of the invention, when taken with the figures of the drawing. The scope of the invention, however, is limited only by the claims appended hereto.

### BRIEF DESCRIPTION OF THE DRAWINGS

FIG. 1 is a front elevation of a door with entablature that characterizes features of the invention;

FIG. 2 is a perspective view of a portion of a lintel and casing joint for use with the structure shown in FIG. 1; and

FIG. 3 is a detail perspective view of a portion of a molding for final attachment to the door shown in FIG. 1.

### DETAILED DESCRIPTION OF THE INVENTION

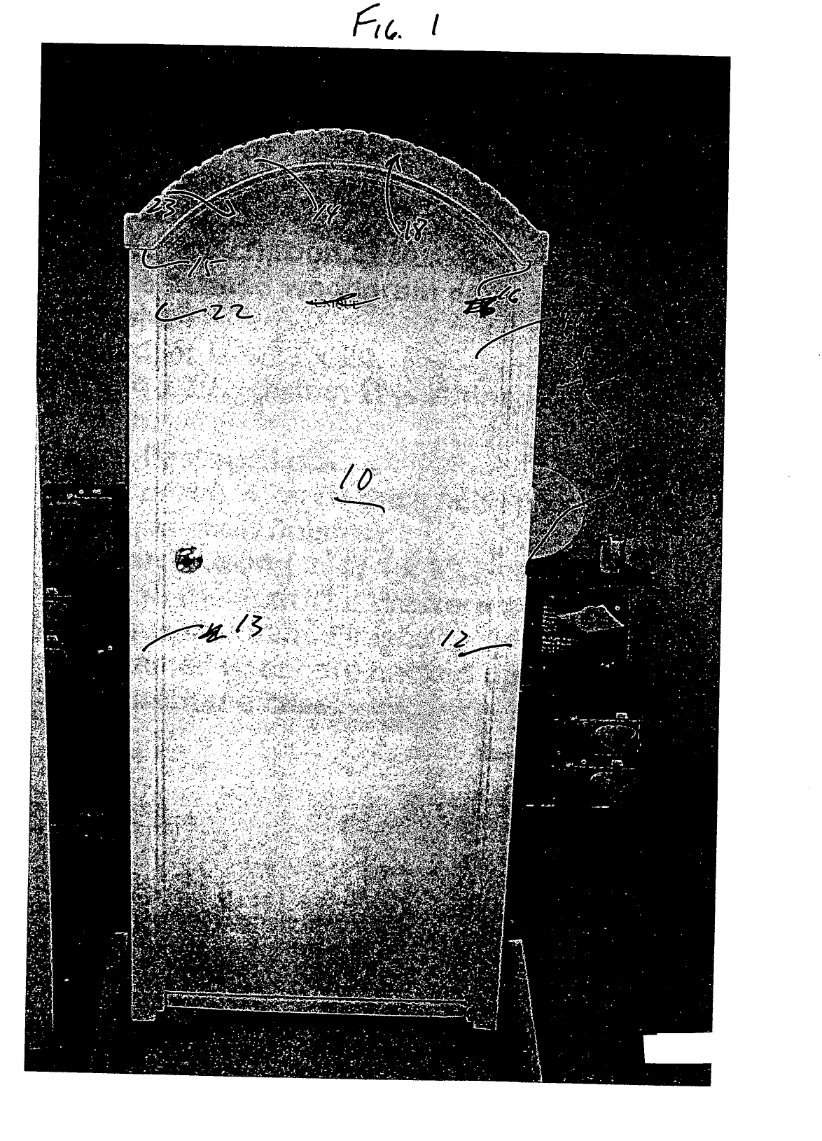

As best shown in FIG. 1, a door 10 prepared for installation between a pair of vertically mounted door jambs (not shown) at a construction site has a flat side, 11 secured between two vertical moldings 12, 13. A fascia 14 having a curved profile is mounted between the uppermost sides 15, 16 of the moldings 13, 12.

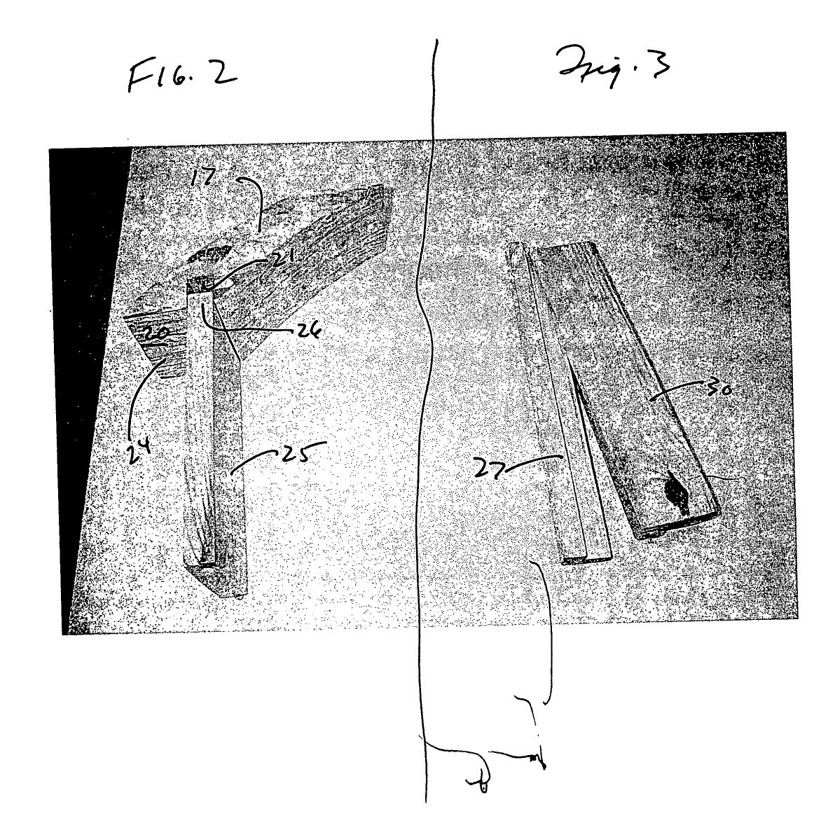

Behind the moldings 12, 13 and the curved fascia 14, not shown in FIG. 1, but best illustrated in FIG. 2 is a curved lintel 17 that provides the entablature 18 for the door 10 (FIG. 1). The curvature of the lintel 17 both matches and provides support for the fascia 14. (FIG. 1). As depicted in FIG. 2, the lintel 17 has on an end 20 a mortise 21. The mortise 21 is formed in the lintel end 20 near to vertical and arcuate edges 22, 23 (FIG. 1) of the door 10. The balance of the lintel end 20, away from the mortise 21, is a flat surface 24 that abuts and rests on an uppermost end of one of the door jambs (not shown in the drawing). A corresponding flat surface on the other end of the curved lintel 17, also not shown in the drawing, rests on an uppermost end of a door jamb on the opposite side of the door 10. Further is this respect, the curvature or profile of the lintel 17 compliments the adjoining arcuate door edge 23 to permit a snug fit between the door edge 23 and the lintel 17 when the door 10 is closed as illustrated in FIG. 1.

A vertically mounted casing 25 (FIG. 2) has an upper end 26 that is seated in the lintel mortise 21. A similar casing and mortise combination (not shown in the drawing) is provided on the opposite side of the door 10.

FIG. 3 shows a portion of molding strips 27, 30 for final assembly with the door 10 (FIG. 1) at the building site, as described subsequently in more complete detail.

In operation, at the building site, an opening is prepared in a wall 31 (FIG. 1) or the like that is sufficient to accommodate the door 10, the curved lintel 17 (FIG. 2), the vertical casing 25 and the companion vertical casing (not shown) on the opposite side of the door 10. The combination of the door 10 its associated casings 25 and the curved lintel 17 are inserted into the opening in the wall 31. So installed, the moldings 12, 13 and the decorative fascia 14 are pressed flush with the portion of the wall 31 that forms the opening for the door 10.

Installation is completed by securing the casing 25 and its companion casing (not shown) on the opposite side of the door 10 to their respective vertical door jambs (also not shown). The molding strips 27, 30 are then attached to the casings, of which only the casing 25 is shown, on the side of the door 10 that is opposite to the side shown in FIG. 1 in order to lay flush against the adjoining wall. A fascia (not shown) for this opposite side of the door 10 also is attached to the adjoining side of the curved lintel 17 to complete the molding on the opposite flat side of the door 10.

Thus, there is provided in accordance with the invention a substantial improvement in archways, archway construction and structures for doors that have irregular top ends.

1. An entablature for an archway comprising at least one fascia having an irregular profile, a lintel having two ends, said lintel being attached to said fascia, and having a profile that corresponds to said fascia profile, said lintel having a mortise formed in at least one of said ends and a casing having an end, said casing end being seated in said mortise.

2. An entablature according to claim 1 further comprising a flat surface formed on at least one of said lintel ends for supporting the entablature.

3. A method for assembling an archway entablature for a structure having at least two sides comprising the steps of mounting an irregular fascia on one side of a corresponding two sided irregular lintel, forming an opening in the structure that generally matches said irregular lintel, inserting said irregular lintel into said opening and attaching another irregular fascia to said other side of said lintel to enable said fascia to be flush with said respective sides of the structure.

4. A door for construction site installation comprising a door having a first generally flat side and a second generally flat side opposite to said first side, four door edges, at least one edge of which is arcuate, and two edges of which are generally parallel with each other, at least one casing adjoining one of said parallel edges, a molding strip attached to said at least one casing on one of said flat door sides, a lintel having a profile that complements said arcuate door edge to permit a snug fit therebetween, and a curved fascia attached to said lintel on said one flat door side.

5. A door according to claim 4 wherein said lintel has at least one end, said lintel having a mortise formed in said end and a generally flat surface therebeyond said casing having an end received in said lintel mortise.

6. A method for installing a door having a curved edge and an entablature in a structure comprising the steps of forming an opening in the structure to accommodate the door and at least a portion of the entablature, securing individual casings each to opposite sides of the door, attaching a lintel to said casings, said lintel having a curved surface that generally matches the curved door edge, securing a curved fascia to said lintel on one side of the door, securing respective molding strips to each of said casings on said one door side, inserting said door, said lintel and said casings into said structure opening, and attaching further molding strips to said casings and another curved fascia to said lintel, said further molding strips and said another curved fascia being attached on another side of the door.
